(19) United States
(12) Patent Application Publication
(10) Pub. No.: US 2025/0191593 A1
(43) Pub. Date: Jun. 12, 2025

(54) Audio Codec Bitrate Using Directional Loudness

(71) Applicant: Samsung Electronics Co., Ltd., Suwon-si (KR)

(72) Inventors: Sunil Bharitkar, Stevenson Ranch, CA (US); Toni Hirvonen, Santa Clarita, CA (US)

(21) Appl. No.: 18/939,275

(22) Filed: Nov. 6, 2024

Related U.S. Application Data
(60) Provisional application No. 63/608,097, filed on Dec. 8, 2023.

(51) Int. Cl. G10L 19/002; G10L 19/02

(52) U.S. Cl. CPC G10L 19/002; G10L 19/02

(57) ABSTRACT

In one embodiment, a method includes accessing a window of audio that includes audio signals. The method further includes determining, for each of the audio signals, a power of that signal relative to a reference audio signal; determining, for each of the audio signals and based on the determined relative power of that signal, a gain to apply to the audio signal relative to the reference audio signal, where the gain depends on frequency and on directionality relative to a listener; and encoding the audio so that bandwidth is allocated based on directionality relative to the listener by allocating an amount of bandwidth to each of the audio signals based on their respective frequency-dependent and directionality-dependent determined gains.

### PRIORITY CLAIM

This application claims the benefit under 35 U.S.C. § 119 of U.S. Provisional Patent Application No. 63/608,097 filed Dec. 8, 2023, which is incorporated by reference herein.

### TECHNICAL FIELD

This application generally relates to determining an audio codec bitrate using directional loudness.

### BACKGROUND

Audio codecs are used to encode audio information and decode audio information according to an encoding scheme. Encoding compresses the audio stream, thereby reducing the bit-rate used to represent that audio stream. Decoding decompresses a compressed audio stream. Compression can introduce artifacts to an audio stream, including temporal artifacts and spatial artifacts (e.g., a sound that is intended to play from the user's left instead plays from the user's center).

Compressing audio is increasingly common as media, including audio, is streamed. While audio on fixed storage media (e.g., Blu-ray) typically does not require compression, many streaming applications benefit from some compression of audio information. For example, streams may be data limited, and compression can improve the quality of audio heard by a listener by compressing the audio during to transmission to comply with data-rate requirements, while retaining important information in the audio stream that impacts listening. As another example, bandwidth is often increasingly devoted to video in a mixed media stream, and therefore reducing the data devoted to audio can improve the overall streaming experience, provided that the audio is not overly degraded as part of the compression process.

An entertainment system often involves multiple loudspeakers that play audio. For example, an entertainment system may include a pair of left-right stereo loudspeakers, a subwoofer, a center loudspeaker, a pair of left-right surround loudspeakers, and/or a pair of left-right rear surround loudspeakers. The number of loudspeakers in a system are often referred to by an x.y channel convention, where x is the number of loudspeakers used in the system and y refers to the number of subwoofers used in the system. Encoding and compression can be performed per channel in a channel-based audio representation, or can be performed for object-based audio, which assigns audio information to one or more objects that may or may not move over time.

### BRIEF DESCRIPTION OF THE DRAWINGS

FIG. 1 illustrates an example audibility curve that illustrates how well a listener can perceive a particular tone as a function of frequency and sound pressure level (SPL).

FIG. 2 illustrates an example in which listener perception of sound loudness is plotted as a function of directionality and signal frequency.

FIG. 3 illustrates an example of audibility varying based on relative directionality.

FIG. 4 illustrates an example approach for determining an audio codec bitrate using directional loudness.

FIG. 5 illustrates an example implementation of the method of FIG. 4.

FIG. 6 illustrates an example interpolation of gain curves at various frequencies and at two different SPLs.

FIG. 7 illustrates SPL interpolation for gain curves.

FIG. 8 illustrates example gain curves for a particular frequency, directionality, and SPL relative to a reference signal that is directly in front of the listener.

FIG. 9 illustrates an example computing system.

### DESCRIPTION OF EXAMPLE EMBODIMENTS

Audio codecs are used for compressing bitrates for speech, music, and cinematic content, often for streamed media content over the internet. The audio content can be channel-based such as stereo, 5.1 (surround), 7.1.4 (immersive with height loudspeakers); but the audio content may also (or in the alternative) be represented using channel-agnostic objects. In either case, the audio channels or audio assigned to particular objects is encoded and sent through the internet to be decoded by a decoder, e.g., on consumer devices such as a smartphone, TV, etc. Channel-based audio signals convey significant amount of information such as music, ambience, and dialog, and objects may be relatively sparser throughout the content. However objects are critical as they can deliver significant perceptual cues around the viewer, e.g., when recreating the sound of a helicopter flybys.

Audio codecs rely on the principle of psychoacoustic masking, where fundamentally loud sounds mask quieter sounds, and use this principle to encode audio signals. Existing codecs assign equal bitrate per channel or per object in the content. This can quickly become very expensive in terms of bitrate if the number of objects is not limited in the content creation. This constraint (limiting the number of channels/objects) on bitrate, due to distribution requirements (e.g., low audio datarate), can impede creative expression for cinematic content. Furthermore, if high object counts are present, then lossy compression techniques will introduce audible artifacts to keep the audio stream within datarate requirements (e.g., 256 kbps).

Audibility—how well a human listener can hear a sound—varies with frequency. For example, frequencies around 3 kHz can be heard at much lower decibel levels than frequencies around 100 Hz or around 15 kHz. In other words, greater sound-pressure levels are required for a 15 kHz signal to be perceived by a human listener as being the same volume as a 3 kHz signal.

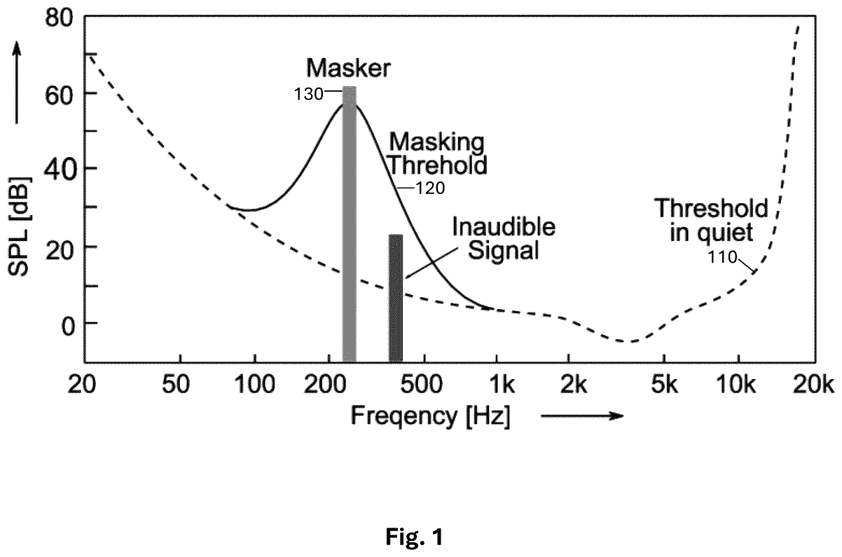

Audibility of a particular tone depends not only on frequency but also on the presence of other tones in an audio signal. Specifically, audibility of a tone can depend on the volume and frequency of another tone present in the signal. FIG. 1, taken from Herre, J. et al. “Psychoacoustic Models for Perceptual Audio Coding—A Tutorial Review,” Appl. Sci., vol. 9, 2019, illustrates an example in which audibility curve 110 illustrates how well a listener can perceive a particular tone as a function of frequency and sound pressure level (SPL). Curve 110 represents the SPL at which a particular sound is played, as a function of frequency, for the tone to be heard audibly (i.e., areas under curve 110 are not audible to the listener). Curve 120 illustrates that, when example masker tone 130 is present, then the presence of masker tone 130 changes how audible tones are to the listener, i.e., tones now need to be played at SPLs identified by curve 110 as adjusted by curve 120. As illustrated in FIG. 1, audibility is frequency dependent, in that the required adjustments to curve 110 in the presence of another masking tone vary based on the frequency of the target tone and on the frequency of the masking tone. In addition, audibility depends on the SPL of the masking tone.

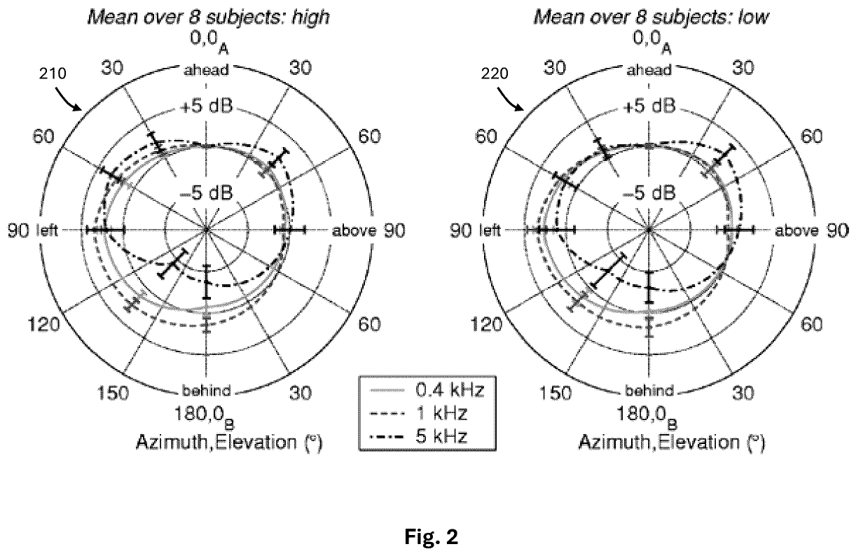

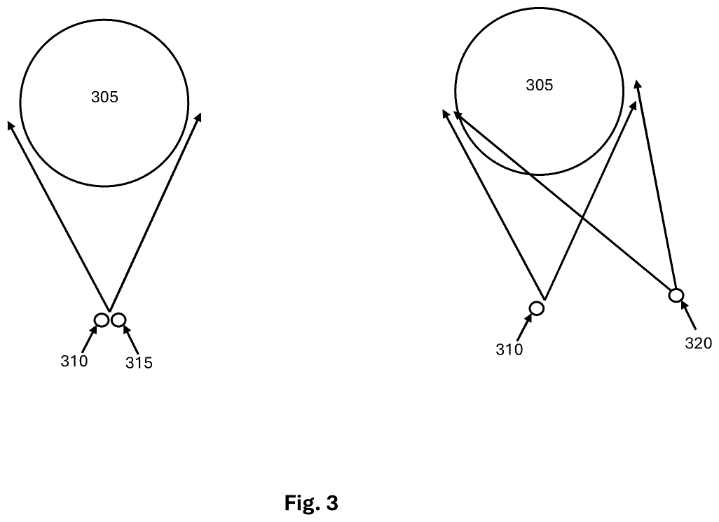

As explained more fully below, existing codec compression techniques allocate bits to an audio signal based on the relative perceived loudness of that signal (which is a function of frequency). However, a person's perception of a signal depends not only on the frequency of the signal, the SPL of the signal, and the frequency and SPL of any additional signals, but also on the directionality of the signal relative to the listener. For example, a tone's perceived loudness depends on where the source of that tone is located relative to the listener, and this directional dependency is also a function of frequency and on the SPL of the signal, as discussed more fully in connection with FIG. 2, below. In addition, the spatial separation between a target tone and a masking tone affects the audibility of the target tone: a masking tone that is co-located with a target tone will more greatly affect the audibility of the target tone than if the masking tone is spatially, directionally separated from the target tone, i.e., if the target tone source and the masking tone sources are in different directions from the user. For instance, in the example of FIG. 3, a target tone 310 is heard differently by listener 305 when accompanied by masking tone 315 compared to masking tone 320, due to the different directionalities of masking tones 315 and 320 relative to listener 305.

The techniques described herein include a codec compression approach that accounts for directionality when allocating bandwidth for the compression. In other words, the compression techniques described herein account for the fact that directionality impacts the audibility (and therefore, perception) of audio when allocating bandwidth to the various portions of the audio.

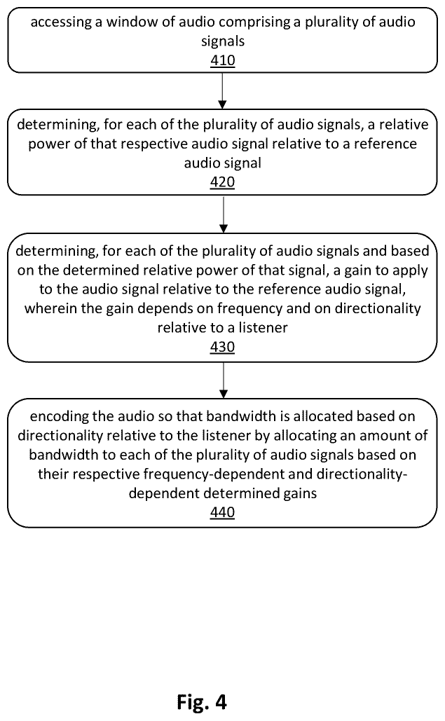

FIG. 4 illustrates an example approach for determining an audio codec bitrate using directional loudness. Step 410 of the example method of FIG. 4 includes accessing a window of audio that includes audio signals. When the audio is channelized, the different audio signals may be different channels. These channels may be referred to as frames, such that the window of audio may be represented as a vector x={x₁, . . . , xₙ}, where xₙ refers to the audio in a particular channel (e.g., in a 5.1 system, the index n goes from 1 to 6). In particular embodiments, the audio signals may be different object-based audio signals, e.g., audio signals associated with different objects, and these audio signals may spatially move when their corresponding object moves. In particular embodiments, the window of audio may be made up of a set of samples of an analog audio input.

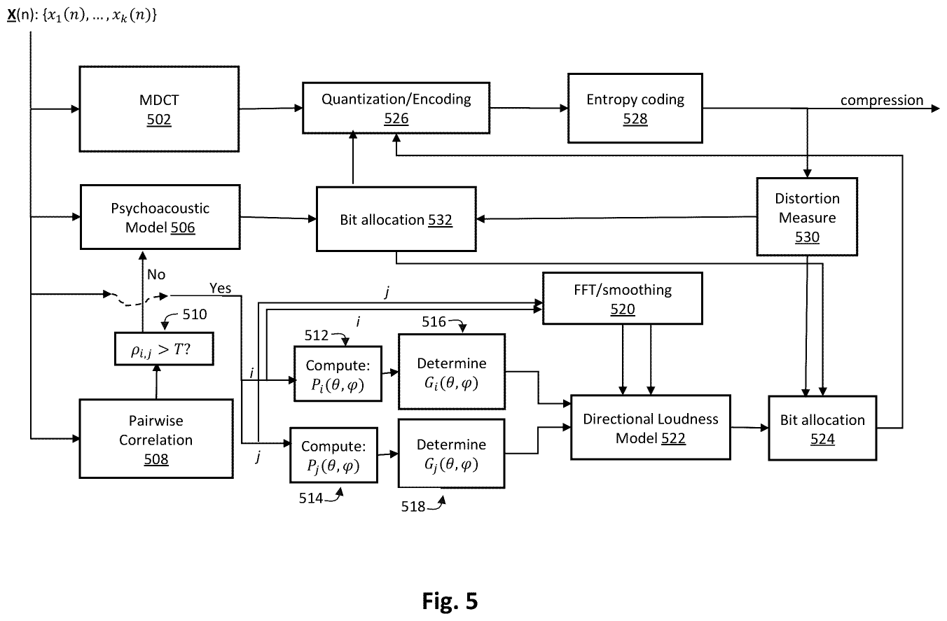

Particular embodiments may determine whether a pairwise correlation between two separate audio signals exceeds a threshold correlation. FIG. 5 illustrates an example implementation of the method of FIG. 4 in which the input window of audio x is channelized in k frames. In block 508, the pairwise correlation ρ_{i,j} between two channels i and j is computed. The pairwise correlation may be computed using time analysis or time frequency analysis. At block 510 in the example implementation of FIG. 5, the pairwise correlation for the two channels is compared to a threshold T. For example, T may be 90%, in particular embodiments. If the pairwise correlation is greater than the threshold, then the two input audio signals i and j are sufficiently correlated to perform directionally-based bit allocation, as described more fully below. The pre-processing analysis in the side-chain (viz., computing the correlation coefficient) is not required; however, given that the directional loudness subjective testing results in FIG. 2 were done with the same stimuli in all directions, this pre-processing step is therefore appropriate in this example. However, other embodiments may not determine pairwise correlation between signals.

If the pairwise correlation is not greater than a threshold, then bit-rate allocation on the input audio may be performed using existing techniques, an example of which is described at a high level as follows. In general, audio coding can use transform coding or waveform coding, and the techniques of the example of FIG. 4 can be applied to either use case. In existing compression approaches, input audio is passed to a MDCT (modified discrete cosine transform) block 502, which performs a time-frequency analysis with transforms of the input audio. The input audio (which may include speech, music, and/or other sounds) may be channelized or may be objected-based; for instance, in a channelized representation the input audio may be represented as xₜ(k), where the index t refers to the frame (or channel) number and k is the sample index in frame t. For instance, a window of audio may include 2N samples in a frame (e.g., N=1024), and then k would be an index that goes from 1 to 2048. The value of x( ) represents the amplitude of the audio signal at the corresponding index of the sample in the specified frame.

The output of MDCT block 502 is the MDCT coefficients Xₜ(m) for the specified channel and samples of the input audio. The MDCT formula is:

$${X}_{t} ( m ) = \sqrt{\frac{2}{N}} {\sum }_{k = 0}^{2 N - I} w ( k ) {x}_{t} ( k ) cos ( \frac{π}{4 N} ( 2 k + 1 + N ) ( 2 m + 1 ) )$$

$$m = 0 , … , N - 1$$

where the window is, for example:

$$\begin{matrix}w ( k ) = sin ( \frac{π}{4 N} ( 2 k + 1 ) ) \\ k = 0 , … , 2 N - 1\end{matrix}$$

The MDCT transform provides a compact representation of the input signal from 2N input signal samples, in a given frame, to N coefficients, and these N coefficients can then be converted to binary format for bit allocation. Continuing the example of FIG. 5, existing techniques use a quantization/encoding block 526 to encode the input MDCT coefficients as a b-bit binary output for each frame. Bit-allocation block 532 iteratively determines how may bits to allocate to each frame for the given input audio based on psychoacoustic (auditory) model 506 and distortion measure module 530. Quantization/encoding block 526 may, for example, use a PCM waveform to digitize an analog audio signal, and then may use differential PCM to create a 2-bit digitization of the analog audio signal. There is a quantization noise error e arising from coarsely quantizing an amplitude value. Encoding techniques aim to get the quantization noise to be imperceptible, based on the psychoacoustics hearing threshold (which is sensitivity of human hearing in a quiet environment) by using an acceptable number of bits to encode the signal: a bit-rate that is too high will needlessly consume bandwidth, while a bitrate that is too low will introduce audible artifacts, e.g., because the quantization noise is not well masked.

In existing techniques, psychoacoustic model 506 outputs a noise-to-mask (NMR) ratio, e.g., in frequency bands from 20 Hz to 20 kHz. However, NMR in existing compression techniques only accounts for masking threshold based on loudness, e.g., as illustrated in FIG. 1, without taking into account the directionality of audio signals and how that directionality influences a listener's perception of the audio. In contrast, the techniques described herein can obtain an NMR that is based on directionality, e.g., NMR(θᵢ,ϕᵢ) for the i-th audio signal at azimuth θᵢ and elevation ϕᵢ.

Returning to existing techniques, distortion measure block 530 computes a distortion D that is given by:

$$D = \frac{1}{{N}_{f}} {\sum }_{i = 1}^{{N}_{f}} E [ {( {x}_{i} - {\hat{x}}_{i} )}^{2} ] = \frac{1}{{N}_{f}} {\sum }_{i = 1}^{{N}_{f}} {d}_{i} ,$$

where xᵢ and \hat{x}ᵢ denote the i-th unquantized and quantized transform coefficients, respectively; and E[.] is the expectation operator. Let nᵢ be the number of bits assigned to the coefficient xᵢ for quantization, such that:

Σᵢ₌₁^{N}^{_{f}}nᵢ≤N.

Here, N_{f} represents the total number of transform (e.g., MDCT) coefficients. Bit-allocation block 532 can then allocate bits to the channels, e.g., if xᵢ are uniformly distributed, then a uniform distribution such as:

$${n}_{i} = [ \frac{N}{{N}_{f}} ]$$

may be used. Other allocation schemes (e.g., Gaussian allocations schemes) may be used; Table 3.1 in A. Spanias, and T. Painter, Audio Signal Processing and Coding, J. Wiley & Sons, 2007. identifies an example of uniformly distributed coefficients and Gaussian-distributed coefficients for given input vectors. Returning to FIG. 5, once quantization/encoding block 526 encodes each channel (in this example) using the number of bits determined by bit-allocation block 532, then entropy coding block 528 is used to replace particular encodings in the bit stream with a unique code word prior to bit packing and transmission of the stream, in order to compress the bit stream.

Returning to FIG. 4, step 420 of the example method of FIG. 4 includes determining, for each of the two separate audio signals, a relative power of that respective audio signal relative to a reference audio signal. For instance, in the example of FIG. 5, block 512 illustrates computing the power Pᵢ(θ, φ) for signal i and block 514 illustrates computing the power Pⱼ(θ, φ) for signal j. For each audio signal i and j, the power is determined with respect to a reference audio signal. For example, in a channelized representation, the reference audio signal may be a center channel, and the power for channel n may be represented as

$${P}_{n} ( θ , φ ) = 10 {log}_{10} \frac{{x}_{n}^{2}}{{x}_{c}^{2}}$$

where x_{c} is the audio signal frame for the central channel, i.e., at (θ, φ)=(0,0). Other channels or objects may be used as the reference audio signal, in particular embodiments.

Step 430 of the example method of FIG. 4 includes determining, for each of the audio signals and based on the determined relative power of that signal, a gain to apply to the audio signal relative to the reference audio signal, where the gain depends on frequency and on directionality relative to a listener. For instance, for signal i, the gain determined for the signal is Gᵢ(θ, φ) (block 516) and for signal j the gain is Gⱼ(θ, φ) (block 518). FIG. 2 illustrates an example in which listener perception of sound loudness is plotted as a function of directionality and signal frequency. Graph 210 illustrates perception for sounds played at an SPL of 65 dB, and graph 220 illustrates perception for sounds played an SPL of 45 dB. The graphs illustrate the effect of directionality in terms of (θ, φ), where θ represents rotation to the listener's left, from 0 to 180 degrees, and φ represents an elevation rotation, from 0 degrees (no elevation) to 90 degrees (straight above the listeners). As a result, (0,0) represents a direction directly in front of the listener, and (180, 0) represents a direction behind the user.

FIG. 2 illustrates the frequency dependent, directional dependent sensitivity listeners have to sounds. The graphs identify the SPL (in dB) at which certain frequencies are played in order for a human listener to perceive those sounds as being at the same volume, as a function of the directionality of the sound. For example, a 5 kHz sound to the left side of the listener must played at a higher SPL than a 5 kHz sound played directly in front of the listener for each sound to be perceived as equally loud by the listener. In addition, a 0.4 kHz sound played behind the listener must be played at a higher SPL than a 5 kHz sound played behind the listener for the listener to perceive each sound as being played at the same volume.

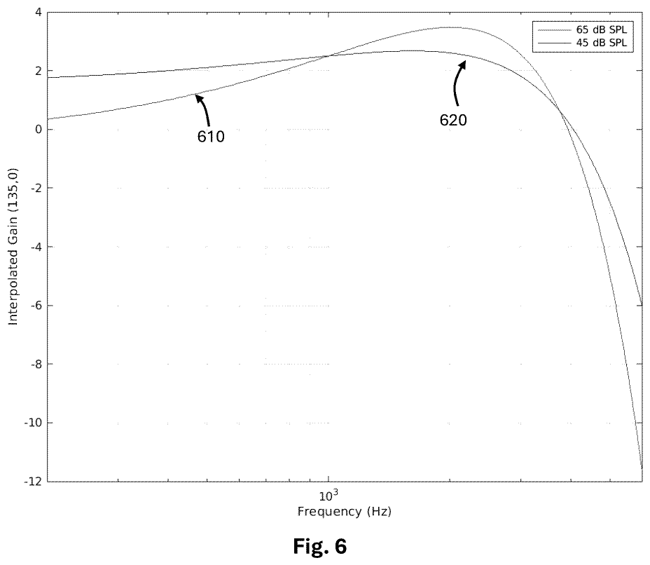

FIG. 2 illustrates gains that must be applied to 0.4 kHz, 1 kHz, and 5 kHz signals at 65 dB and at 45 dB (based on averaging the responses of a number of listeners), but audio signals may occur at other frequencies and at other SPLs. In general, while a more comprehensive repository of listener data may be built, it would be resource intensive to gather data at every frequency band and at every SPL. Therefore, in particular embodiments it may be necessary to interpolate various aspects of listener data to compress the actual audio signals encountered in a particular window of audio. For example, FIG. 6 illustrates an example interpolation of gain curves (i.e., the gain at which the same loudness is perceived, relative to a reference direction, e.g., (0,0)) at various frequencies at 65 dB SPL (curve 610) and at 45 dB SPL (curve 620). These example gain curves are for a direction of (135°, 0°) relative to the user. Thus, FIG. 6 illustrates gain curves at particular SPLs and a particular directionality interpolated across a range of frequencies (e.g., at many more frequencies than the data collected in FIG. 2 identifies).

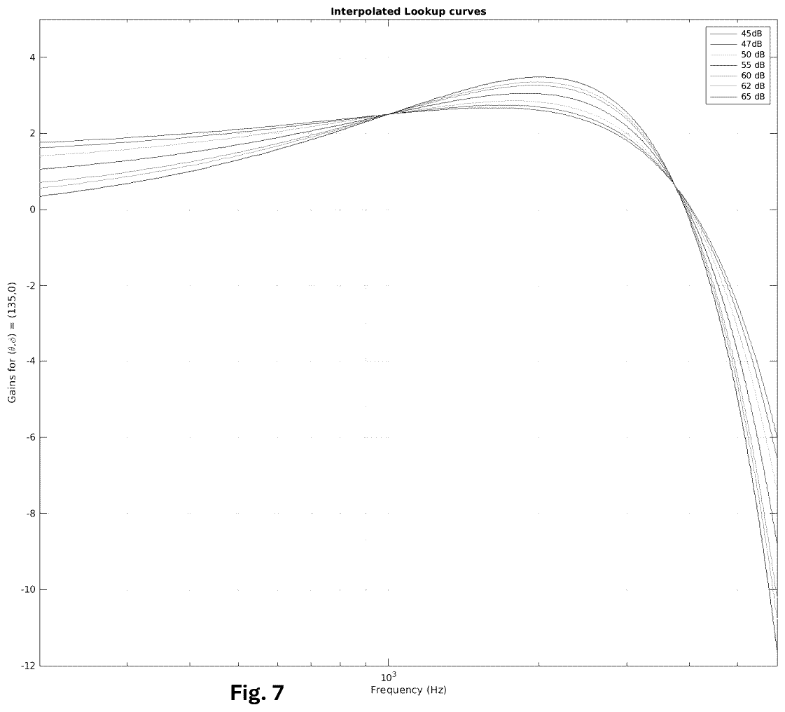

FIG. 7 illustrates SPLs interpolated for gain curves, again at a direction of (135°, 0°) relative to the listener. This interpolation can be used for SPLs other than those represented in listener data (e.g., SPLs beyond those identified in FIG. 2).

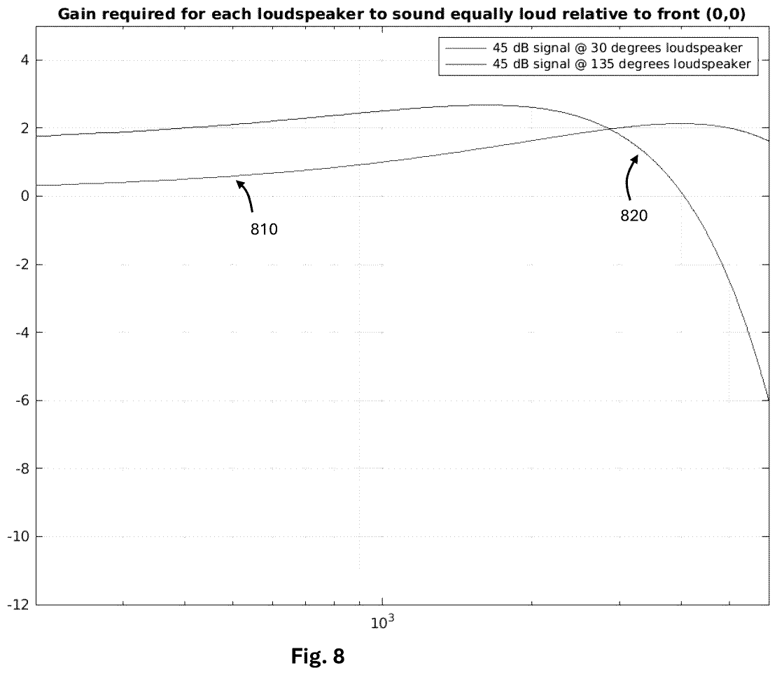

FIG. 8 and psychoacoustic-based directional loudness model 522 illustrate an example of determining the gain for a particular frequency, directionality, and SPL relative to a reference signal that is directly in front of the listener. Curve 810 illustrates the gain required for a 45 dB signal at (30°,0°) and curve 820 illustrates the gain required for a 45 dB signal at (135°,0°). As illustrated in FIG. 5, FFT/smoothing block 520 may be used to compute the frequency-dependent signal using the Fast Fourier Transform to be used for comparisons with the frequency-dependent directional loudness curves of FIG. 7. Optionally 1/N (e.g., N=3) frequency domain smoothing can be applied to the FFT output to get a smoother response of the frequency domain representation.

Once the appropriate frequency-dependent, SPL-dependent, and directional-dependent gain is identified in step 430 for both of the signals i and j (which in this example are correlated signals), then step 440 includes encoding the audio so that bandwidth is allocated based on directionality relative to the listener by allocating an amount of bandwidth to each of the audio signals based on their respective frequency-dependent and directionality-dependent determined gains. For example, with respect to FIG. 5, bit allocation block 524 allocates bits based on both psychoacoustic model 506, described above, and on directionality. For example, bit allocation block 524 may take the converged B kbps from bit allocation block 532 and, for a reference audio signal (e.g., a center channel at (0,0) relative to the user) may set the center-channel bitrate be to B/N (where N is the number of audio channels). For the other audio signals (e.g., channels), bit allocation module 524 may refine the bitrates, using the output of directional loudness block 522, such that Σ_{k≠c} bₖ+b_{c}=B. For example, the output Fᵢ(ω) from the FFT/smoothing block for channel i may be normalized by the RMS level for the given direction (θᵢ, ϕᵢ) for channel i and then compared with the interpolated gain curve (e.g., FIG. 7) for a given signal level (e.g., 65 dB). The MDCT coefficients associated with the frequency bands for the given channel i that exceed the value of the specified curve would be coded at a higher bitrate than other MDCT coefficients that did not exceed the value of the specified curve. Furthermore, to set the bits allocated for a given MDCT coefficient between channels, 524 includes a comparison process that first determines the difference between the gain curve and FFT/smoothing output for each channel, and then the bits assigned are progressively reduced as the difference becomes smaller For example, the left channel (30,0) FFT output may have a larger positive valued difference compared to the (135,0) channel and accordingly more bits are assigned to the MDCT coefficients in the left channel. Particular embodiments may also use statistical redundancy techniques for reducing bitrate based on inter-channel analysis. While FIG. 5 illustrates an example in which bit allocation block 524 is used to modify the output of bit allocation block 532, in particular embodiments the output of directional loudness block 522 may instead by passed directly to bit allocation block 532, which then determines bit rates based on both psychoacoustic models 506 and 522.

While the above discussions use channels as examples of audio input, object-based audio signals may be used. For example, the position of an audio-based object (e.g., as determined based on metadata about the object or based on inferred position, e.g., from analysis of a corresponding video) may be used to identify the directionality of the corresponding audio relative to the user, and this directionality may then be used to determine the corresponding compression for that audio, as described above (i.e., in general, directions with lower NMR receive relatively more bits).

While the description above discusses particular frequencies, in practice the techniques described herein may be applied to frequency bands, where each frequency in the band is treated similarly, and frequency bands are generally aligned with human perceptions of frequencies so that frequencies within a band are perceived similarly.

The techniques described herein dynamically control the bitrate, during audio encoding, based on directional loudness of the audio signals. This results in improved bit allocation, based on directional loudness sensitivity, enabling more objects or channels to be compressed and transmitted at a given overall bitrate (e.g., 256 kbps), and/or reducing the bitrate required to compress and transmit a particular number of objects or channels.

In particular embodiments, the characteristics of a reproduction space may impact a listener's perception of audio content. For example, a large room has different audio characteristics than a small room, and a room with many echoes has different audio characteristics than a dry, echoless room. In particular embodiments, these characteristics may influence the encoding used to compress audio, i.e., compression may be based on the expected (or actual) characteristics of the playback reproduction space. These characteristics may be reflected in a psychoacoustic model (e.g., model 506). For example, reverb or reflections can diminish the amount of spatial unmasking; as a result, reflections arriving from various directions make it more difficult for the hearing system to separate each channel or object from each other. With headphone reproduction, typically content is rendered with simulated Head-Related Transfer Functions (HRTFs), which can also introduce effects that lessen the spatial unmasking.

The unmasking estimation in the coding of material aimed for either or both situations can be relaxed (i.e., the masking may be reduced) according to the estimated amount of energy leakage from reflections. This estimate can be based on rough general heuristic (e.g. 3 dB max amount of spatial unmasking in typical rooms), or on a more complicated statistical room acoustic/absorption modeling of reflections and reverb. In case of real-time streaming, instead of statistical average estimates, the room properties can alternatively be sent upstream to the encoder and used to optimize the audio codec bit allocation specifically to that listening situation. In particular embodiments, categories of room characteristics may be used define the reproduction characteristics, e.g., “living room” vs “headphones” vs “cinema.”

Regarding extended-realty (XR, which includes augmented reality, virtual reality, and mixed reality) applications, in totally unrestricted XR applications, each channel or object of the audio content can potentially be listened in isolation if the user perspective moves very close to that position. In that case, it can be beneficial to code all audio elements individually, and not attempt to exploit psychoacoustic masking. However, most virtual environments include some amount of leakage from other audio elements, room effects and reflections.

The reproduction situation can be estimated in the encoding stage. In case it is not totally unrestricted (e.g. a user has only limited range of movement in the environment compared to source locations), a maximum amount of spatial unmasking can be set based on this analysis. Such analysis can utilize e.g. the estimated properties of the virtual acoustic environment and sound attenuation based on average distance information between the audio elements and the user.

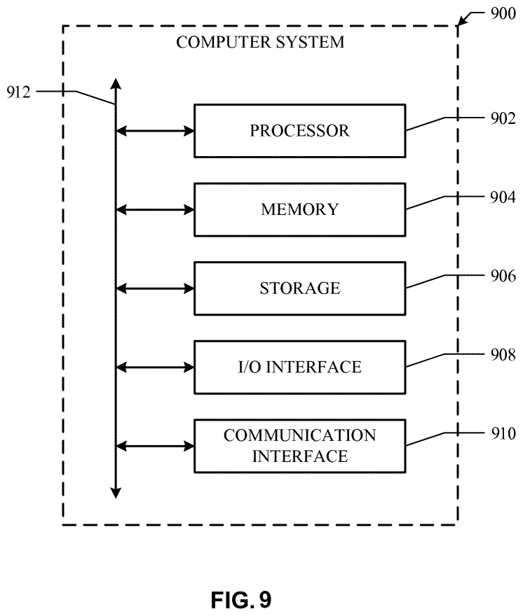

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing a window of audio comprising a plurality of audio signals;
determining, for each of the plurality of audio signals, a relative power of that respective audio signal relative to a reference audio signal;
determining, for each of the plurality of audio signals and based on the determined relative power of that signal, a gain to apply to the audio signal relative to the reference audio signal, wherein the gain depends on frequency and on directionality relative to a listener; and
encoding the audio so that bandwidth is allocated based on directionality relative to the listener by allocating an amount of bandwidth to each of the plurality of audio signals based on their respective frequency-dependent and directionality-dependent determined gains.

2. The method of claim 1, further comprising determining whether a pairwise correlation between two of the plurality of audio signals exceeds a threshold correlation prior to determining the relative power of each of those two audio signals.

3. The method of claim 1, wherein each of the plurality of audio signals are associated with a particular object.

4. The method of claim 1, wherein the plurality of audio signals comprise a plurality of audio frames, each audio frame corresponding to a separate audio channel.

5. The method of claim 4, wherein the reference audio signal comprises a center channel audio signal.

6. The method of claim 1, wherein the gain is determined based at least in part on interpolating gain curves for one or more of (1) frequency or (2) sound pressure level.

7. The method of claim 1, wherein encoding the audio so that bandwidth is allocated based on directionality relative to the listener comprises adjusting a bit allocation determined by a loudness-based psychoacoustic model.

8. The method of claim 1, further comprising adjusting the bandwidth of one or more of the plurality of audio signals based on one or more characteristics of a reproduction space for playing the audio signals.

9. The method of claim 1, further comprising adjusting the bandwidth of one or more of the plurality of audio signals based on a restricted range of movement of the listener in an extended-reality environment.

10. One or more non-transitory computer readable storage media storing instructions that are operable when executed to:
access a window of audio comprising a plurality of audio signals;
determine, for each of the plurality of audio signals, a relative power of that respective audio signal relative to a reference audio signal;
determine, for each of the plurality of audio signals and based on the determined relative power of that signal, a gain to apply to the audio signal relative to the reference audio signal, wherein the gain depends on frequency and on directionality relative to a listener; and
encode the audio so that bandwidth is allocated based on directionality relative to the listener by allocating an amount of bandwidth to each of the plurality of audio signals based on their respective frequency-dependent and directionality-dependent determined gains.

11. The media of claim 10, wherein the instructions are further operable when executed to determine whether a pairwise correlation between two of the plurality of audio signals exceeds a threshold correlation prior to determining the relative power of each of those two audio signals.

12. The media of claim 10, wherein each of the plurality of audio signals are associated with a particular object.

13. The media of claim 10, wherein the plurality of audio signals comprise a plurality of audio frames, each audio frame corresponding to a separate audio channel.

14. The media of claim 13, wherein the reference audio signal comprises a center channel audio signal.

15. The media of claim 10, wherein the gain is determined based at least in part on interpolating gain curves for one or more of (1) frequency or (2) sound pressure level.

16. The media of claim 10, wherein encoding the audio so that bandwidth is allocated based on directionality relative to the listener comprises adjusting a bit allocation determined by a loudness-based psychoacoustic model.

17. A system comprising:
one or more non-transitory computer readable storage media storing instructions; and one or more processors coupled to the one or more non-transitory computer readable storage media and operable to execute the instructions to:
access a window of audio comprising a plurality of audio signals;
determine, for each of the plurality of audio signals, a relative power of that respective audio signal relative to a reference audio signal;
determine, for each of the plurality of audio signals and based on the determined relative power of that signal, a gain to apply to the audio signal relative to the reference audio signal, wherein the gain depends on frequency and on directionality relative to a listener; and
encode the audio so that bandwidth is allocated based on directionality relative to the listener by allocating an amount of bandwidth to each of the plurality of audio signals based on their respective frequency-dependent and directionality-dependent determined gains.

18. The system of claim 17, further comprising one or more processors that are operable to execute the instructions to determine whether a pairwise correlation between two of the plurality of audio signals exceeds a threshold correlation prior to determining the relative power of each of those two audio signals.

19. The system of claim 17, wherein each of the plurality of audio signals are associated with a particular object.

20. The system of claim 17, wherein the gain is determined based at least in part on interpolating gain curves for one or more of (1) frequency or (2) sound pressure level.
